(19) United States
(12) Patent Application Publication
(10) Pub. No.: US 2015/0194667 A1
(43) Pub. Date: Jul. 9, 2015

(54) HYDROPHOBIC AND OLEOPHILIC SPONGE-LIKE COMPOSITIONS

(71) Applicants: Gordon Chiu, Chatham, NJ (US); Aiping Yu, Waterloo (CA)

(72) Inventors: Gordon Chiu, Chatham, NJ (US); Aiping Yu, Waterloo (CA)

(21) Appl. No.: 14/591,384

(22) Filed: Jan. 7, 2015

Related U.S. Application Data
(60) Provisional application No. 61/924,879, filed on Jan. 8, 2014.
(60) Provisional application No. 62/036,657, filed on Aug. 13, 2014.

(51) Int. Cl. H01M 4/36; C09K 3/32; B05D 1/18; B01J 20/20; B01J 20/26; B01J 20/32; C01B 31/04; B01J 20/02

(52) U.S. Cl. CPC H01M 4/362; C01B 31/043; C09K 3/32; B01J 20/02; B01J 20/205; B01J 20/26; C01B 31/0484; B01J 20/3295; B05D 1/18; H01M 10/0525

(57) ABSTRACT

Hydrophobic and oleophilic compositions are provided. The compositions may be used for absorption of oil from water or organic solvents from water or oil/solvent from any emulsion. The compositions could also have high conductivity and may be used as supercapacitors. Methods to make the compositions are also provided.

### PRIORITY

This application claims priority from United States Provisional Patent Application No. 62/036,657 filed on Aug. 13, 2014 and U.S. Provisional Patent Application No. 61/924,879 filed on Jan. 8, 2014, the contents of which are fully incorporated herein by reference.

### FIELD OF THE INVENTION

The present invention relates to novel hydrophobic and oleophilic materials and methods of their preparation. The present invention provides for materials manufactured from graphene or graphene oxide that are extremely light-weight and sponge-like. These materials are hydrophobic can be used in a method to separate oil from water, and have excellent electrochemical characteristics. These properties rendering them suitable for use in the construction of rechargeable batteries and supercapacitors.

### BACKGROUND OF THE INVENTION

Graphene is a carbon-based material that has been investigated intensively during the last few years due to its unique characteristics. Over the years, graphene has been used for various applications, including electronic devices and batteries. Further, graphene oxide, a graphene derivative, has been studied to as alternative solutions for existing applications of graphene. In addition to using graphene oxide for electronic devices, graphene oxide has been used for various other applications such as applications requiring catalytic oxidation, biotechnological applications, as well as for surfactants.

Due to the many unique characteristics of graphite and graphene, there is a significant need for novel technological applications of graphite- and graphene-based materials. Specifically, the use of graphene- and graphite-based materials in environmental remediation and pollutant removal is of particular interest.

It is possible to remove heavy metal ions from aqueous solutions by placing an object in the solution that is capable of adsorbing the heavy metal ions. This removal of heavy metal ions is largely dependent on the interaction between those ions and functional groups located on the adsorbing material. Therefore, it is understandable that graphene oxide and modified graphene show higher adsorption capacities toward metal ions such as Cu(II), Pb(II), Cd(II) and Co(II) as opposed to pure graphene. Graphene-based materials have also been shown to have high adsorption capacities for organic pollutants, especially benzene-containing compounds. This is due in part to the π-π interactions between graphene and the adsorbate.

When graphene- and graphite-based materials are used to remove pollutants from aqueous solutions, it is important to prevent aggregation between the layers of the graphene- and graphite-based materials. Previous solutions to this problem have been the introduction of magnetic particles in the adsorbent, forming magnetic-graphene composites. The added magnetic particles play an important role in preventing aggregation of the graphene sheets and for that reason, a large amount of research has focused on graphene-Fe₃O₄ composites, investigating the composite's high performance and ease of use regarding pollutant removal as well as separation of the composites from aqueous solutions.

Graphene-based materials have been shown to be useful in adsorption of fluorides, anionic dyes, Pb(II) ions, methylene blue, Cd(II) ions, 1-naphtol, organic dyes, neutral red dyes, arsenic, Hg(II) ions, and methyl orange (review of Lu K. et al., Chin Sci. Bull 57, 11 pages 1223-1234, (2012)).

While there are some solutions in the prior art, there is still a need for methods and materials to separate oil from water, that can do so efficiently and inexpensively. Such methods can be used in various industries as well as in several environmental applications.

Further, there is a persistent need for durable and fast rechargeable batteries and super capacitors that could be manufactured economically. There is also a need for the materials to make such batteries.

None of the art described above addresses all of the issues that the present invention does. The invention described in this application provides solutions to the above and further.

### SUMMARY OF THE INVENTION

This invention provides a hydrophobic and oleophilic compositions and methods of production. The compositions of the present invention have uses adsorbing to oil and other pollutants, allowing them to be easily removed from aqueous solution, as well as use with Nickle foams in creating rechargeable batteries and supercapacitors.

In one aspect of the invention, the composition of the present invention is bound to the fibers of a natural or artificial sponge by a binding agent. In another aspect of the invention, the composition of the present invention is provided, wherein said composition can absorb 50 to 200 times of its weight of oil within seconds and 95-98% of the oil can be recovered and recycled to use.

One aspect of the invention is a hydrophobic and oleophilic composition suitable for the rapid adsorption of oil from water, for the rapid adsorption of organic solvents from water, and for the rapid adsorption of oil/solvent from any emulsion.

One aspect of the invention is a hydrophobic and oleophilic composition of matter for adsorbing oil is provided in form of a net, a mat, a chain, a cube, a sphere, or granulate.

Another aspect of the invention is a device to separate oil from water, said device comprising a natural or artificial conventional sponge materials. These natural and artificial conventional sponge materials serve as a scaffold for the graphene to bind to.

Yet another aspect of the invention is a composition that can serve as a supercapacitor as well as part of a Li-battery.

It is an object of this invention to provide a novel, economic, graphene containing a highly oleophilic and hydrophobic sponge-like structure.

It is another object of this invention to provide a novel, economic, material with high hydrophobicity and oleophilicity.

It is an object of this invention to provide novel economic graphene containing composition for separation of oil from water.

It is another object of this invention to provide a method to separate oil from water.

It is yet another object of this invention is to provide a method to extract oil from oil sands waste water as well as shale oil waste water.

It is also an object of this invention to provide a method to efficiently extract oil from oil spills.

It is an object of this invention to provide novel economic nanomaterial for separation of oil from water.

It is a further object of this invention to provide a novel economic nanomaterial with high capacitance.

It is another object of this invention is to provide a supercapacitor with high specific capacitance.

It is yet another object of this invention is to provide rechargeable lithium batteries.

### BRIEF DESCRIPTION OF THE DRAWINGS

FIGS. 1A and 1B show an embodiment of the composition of the invention and a magnification of its structure.

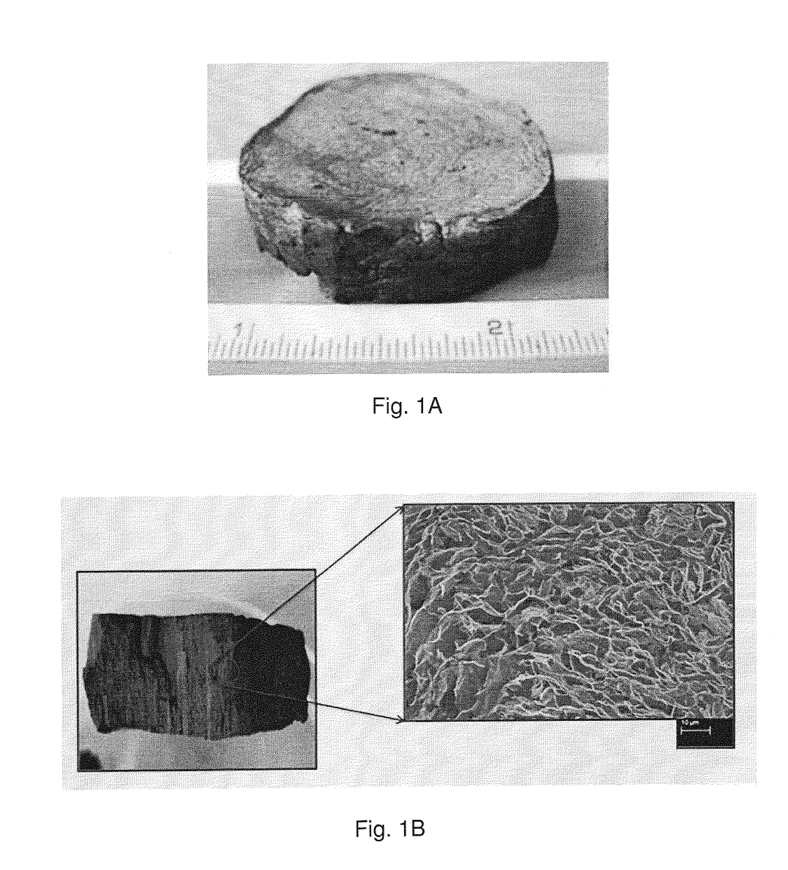

FIG. 2 shows an alternative embodiment of the composition of the invention.

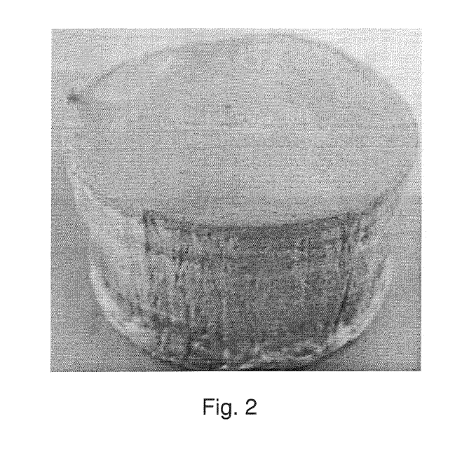

FIGS. 3A, 3B, and 3C show another alternative embodiment of the composition of the invention inside a Nickle-based foam and two different magnifications of this composition, highlighting its structure.

FIG. 4 shows an example of an embodiment of the method of the invention wherein the water droplet stays on top of the sponge while the oil droplets are rapidly absorbed into the sponge.

FIGS. 5A, 5B, and 5C show a demonstration of an embodiment of the present invention absorbing pump oil.

FIGS. 6A, 6B, 6C, and 6D show a demonstration of an embodiment of the present invention absorbing oil from an emulsified water/oil solution.

FIGS. 7A, 7B, and 7C show a demonstration of an embodiment of the present invention absorbing oil from a water/oil solution.

FIG. 8 shows the results of an absorbance test of an embodiment of the present invention in various media.

FIG. 9 shows a button cell supercapacitor of the present invention.

FIG. 10 shows acyclic voltammogram for a button cell supercapacitor of the present invention.

FIG. 11 shows a charge-discharge curve for a button cell supercapacitor of the present invention.

FIG. 12 shows impedance spectroscopy data for a button cell supercapacitor of the present invention.

FIG. 13 shows initial stability data for a button cell supercapacitor of the present invention.

FIG. 14 shows discharge capacity data over a number of cycles for a button cell supercapacitor of the present invention.

### DETAILED DESCRIPTION OF THE INVENTION

### Definitions

By hydrophobic it is meant: a surface or a material is seemingly repelled from a mass of water. Water on hydrophobic surfaces demonstrates a high contact angle, meaning that a droplet of water placed on a hydrophobic surface or material will form a large angle between edge of the water droplet and the plane of the hydrophobic surface or material.

By oleophilic it is meant: a surface or a material have a strong affinity for oils rather than water.

By sponge it is meant: an article made of fibers and spores. The article may be a natural sponge (Luffa sp.) or it may be an artificial sponge made of cellulose fibers, or foamed plastic polymers such as low density polyether, PCA, polyurethane or polyester. The polyester may be double-blown polyester.

By oil it is meant a petroleum or non-petroleum based hydrocarbon containing substances. Examples of petroleum based oils are gasoline, jet fuels, diesel oils, fuel oils, crude oils. Non petroleum oils may be animal fats, oils or greases, fish and marine mammal oils, or vegetable oils such as oils from nuts, fruits, seeds, and kernels.

By graphene it is meant single layer or few layered graphene. Single layer graphene is a single sheet (atomic layer) of sp² bonded atomic carbon. Few layered graphene is several layers of graphene stacked together, either by commensurately (following Bernal AB stacking sequence) or incommensurately.

Graphene is one of the crystalline forms of carbon. In graphene carbon atoms are arranged in a regular hexagonal pattern. Graphene can be described as a one-atom thick layer of the layered mineral graphite. Graphene is a highly conductive material and it is considered to be hydrophobic, meaning that it repels water.

Graphene has been synthesized by many methods including mechanical exfoliation (“Scotch tape” method), chemical vapor deposition, epitaxial growth, and solution based approaches. Fabrication of large-area graphene has been the challenge and an average size of graphene sheets is 0.5-1 μm².

International patent application publication WO2013/089642 for National University of Singapore which is incorporated herein by reference discloses a process for forming expanded hexagonal layered minerals and derivatives from graphite raw ore using electrochemical charging. Mesograf® is large area few layered graphene sheets manufactured by the method disclosed in WO2013/089642. The process comprises immersing at least a portion of graphite ore into a slurry comprising metal salt and organic solvent. The rock is electrochemically charged by incorporation the rock into at least one electrode and performing electrolysis through the slurry using the electrode and thereby introducing the organic solvent and ions from the metal salt from the slurry into the interlayer spacing of the graphite rock to form 1^{st}-stage charged graphite mineral that exfoliates from the graphite rock. The process further includes expanding the 1^{st} stage charged graphite by applying an expanding force to increase the interlayer spacing between the atomic layers. As a result few layered graphene sheets are obtained by one step process from graphite ore. The sheets have an area of 300-500 μm² in average. Mesograf® is few layered graphene made by this method and it is the preferable starting material for compositions of this invention. However, single layer graphene may also be used as well as few layered graphene made by other methods. Either type of graphene is dispersed in ethanol, DMF, NMP or other suitable solvent with mild sonication. Any solvent in which graphene can stay stable with mild sonication can be chosen, typically low melting point solvent is preferred as it is easy to evaporate, such as ethanol or methanol, or NMP. The sonication time is slightly different for single layer and few layered graphene.

The few layered graphene Mesograf® has the high conductive property as well as hydrophobic-character similar as single layer graphene. Mesograf® is obtainable from Graphite Zero Pte. Ltd, Singapore.

Graphene oxide is a compound of carbon, oxygen and hydrogen in variable rations. Traditionally graphene oxide is obtained by treating graphite with strong oxidizers. Maximally oxidized graphene is yellow solid with carbon: oxygen ration between 2.1 and 2.0. Amphioxide™ is graphene oxidized at least 20% and obtained by oxidizing few layered graphene (Mesograf®). Amphioxide™ retains the layer structure of Mesograf®. Graphene oxide, including Amphioxide™ is usually categorized as being highly hydrophilic material. Amphioxide™ is the preferred graphene oxide of this disclosure, it is obtained by and it is obtainable from Grafoid, Inc. Ottawa Canada.

In this invention, sponge-like structures were created by using either Mesograf® (few layered graphene) or Amphioxide™ (graphene oxide made of Mesograf®) as starting materials. It was surprisingly found that the sponge like materials were hydrophobic and oleophilic. Additionally, after reduction of these materials, they exhibited were highly conductive properties.

The invention is now described by means of non-limiting examples. A skilled artisan would understand that various alterations may be done without diverting from the spirit of the invention.

### Example I

### Preparation of Amphioxide™ Sponge Type I

A hydrophobic graphene oxide sponge was made according to the following:
a) Preparing 20 mg/ml Amphioxide™ solution in Di-H₂O;
b) Sonicating the solution for 1 h;
c) Transferring the sonicated material into a dish and leave in a freezer for 6 hours at −30° C.;
d) Removing the dish from the freezer and air blow the top for short time to be sure of the uniform cooling;
e) Using a small amount of liquid nitrogen to cool the bottom of the dish and leave it in a freeze dryer.

The material was found to be hydrophobic and have a high surface area. These characteristics became even more pronounced in Sponge Type II-composition that was made according to Example II.

### Example II

### Preparation of Amphioxide™ Sponge Type II

The Sponge of Type I of Example I was treated as follows:
a) Placing the Type I sponge into furnace by carefully sliding it into a quartz tube;
b) Purging the furnace using 150 s.c.c.m. Argon gas to remove air
c) Waiting for 20 minutes;
d) Continuing to purge with Argon gas for the duration of treatment;
e) Increasing the temperature of the furnace 5° C. every minute until the furnace reaches 900° C.;
f) Holding the temperature constant for 90 min;
g) Allowing to cool naturally until temperature is 100° C.

After the Amphioxide™ Sponge Type II was created, its conductive properties were probed. After determining that Amphioxide™ Sponge Type II was highly conducive, it was combined with a Nickle foam to increase the composition's processability.

### Example III

### Preparation of Amphioxide™ Type II Sponge Inside Nickle Foam

a) Punching Ni-electrodes;
b) Preparing 15 mg/ml Amphioxide™ solution/gel;
c) Dipping coat Nickle foam electrode with Amphioxide™ gel;
d) Placing Nickle foam in 10 ml of 0.05 M EDA solution;
e) Placing the solution in oven for 4 hours at 75° C.;
f) Removing from the oven and rinse the electrodes.

Once the capacitive properties of an Amphioxide™ Type II sponge were increased by placing it in a Nickle foam, it was discovered that a Lithium battery could be developed from this product.

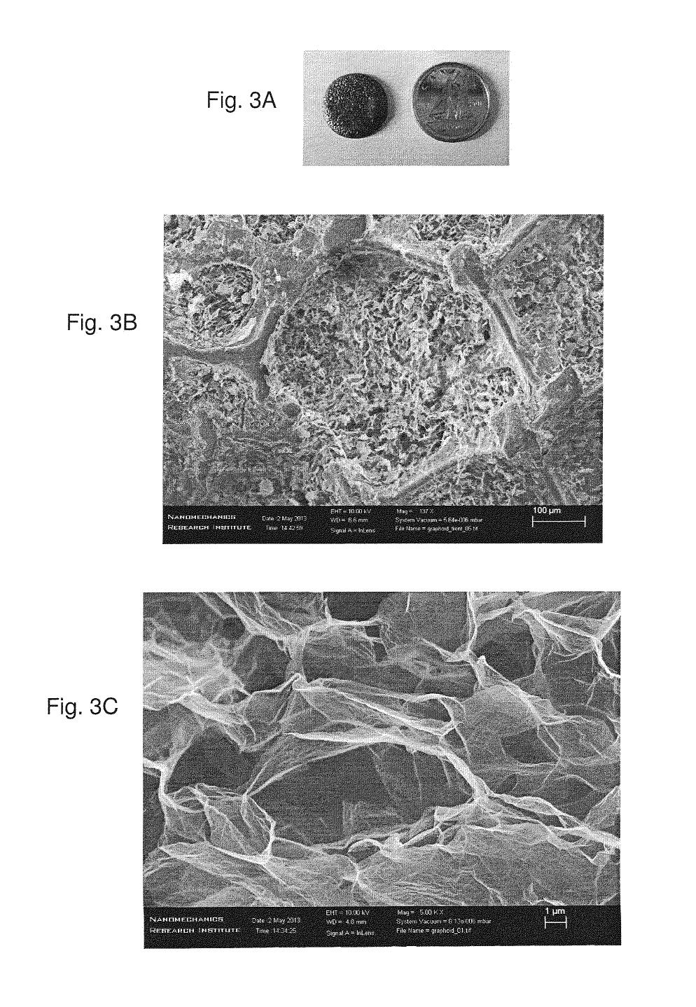

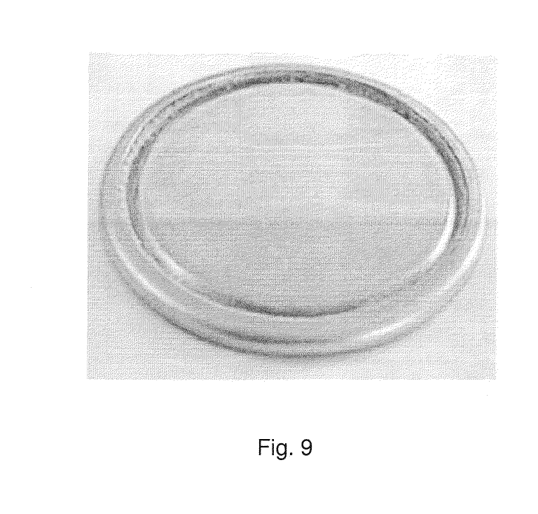

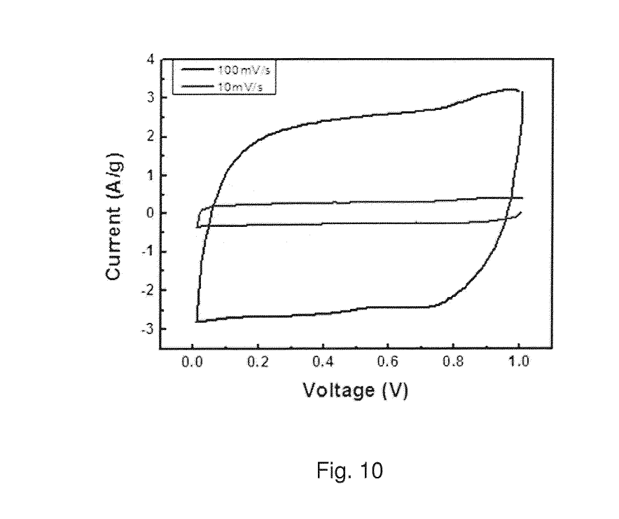

FIG. 3A shows an example of the product of Example III next to a 10 cent Canadian coin to illustrate the size of said product. FIG. 9 also shows an example of the product of Example III. Referring to FIG. 10, a cyclic voltammogram of an example of the product of Example III is provided.

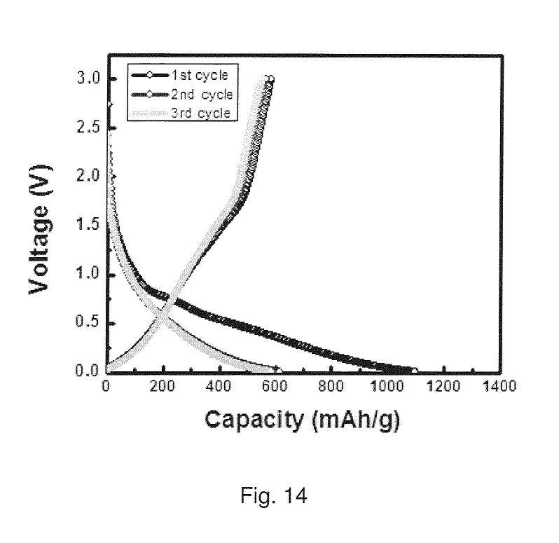

In one embodiment of a Lithium battery constructed with Amphioxide™ sponge Type II inside Nickle foam, the Amphioxide™ is a half-cell, Lithium metal is the reference electrode, and 1M LiPF₆ serves as the electrolyte. This cell started by cycling at 0.1 A/g for a few conditioning cycles and then continued at a rate of 1 A/g. The cell shows excellent performance for 500 cycles. FIG. 14 show graphs detailed the performance of a Li-ion battery comprised of Amphioxide™ Sponge Type II inside Nickle foam. The initial irreversible capacity is 1100 mAh/g, much higher than graphite's theoretical value of 372 mAh/g. The cycle efficiency after stabilization is about 97%.

Definitionally, a supercapacitor is a battery which holds enormous power and charges within a few seconds. Supercapacitors are electric double-layer capacitors or electrochemical capacitors and they can store more energy than conventional capacitors. An important feature of supercapacitors is that there is an extremely narrow gap between the electrodes which are extremely thin layers. This feature allows the supercapacitor to charge large amount of electrical charge in tiny volume.

Modeled off of the Lithium battery constructed out of Amphioxide™ Sponge Type II, a button cell supercapacitor was developed, as shown in FIG. 9. This has a number of benefits since, due to the fact that the integrating electrode and the current collectors are together, the volume/size of such a supercapacitor can be reduced significantly. Further, by tailoring the pores in the composition, performance enhancements can be readily developed. Additionally, this has a specific benefit because in a preferred embodiment the electrode is prepared in one step. Moreover, the capacitance of a preferred embodiment of the button cell supercapacitor is about twice as high the capacitance of the Amphioxide™ sponge Type II alone.

Table 1 shows the initial stability data for the button cell supercapacitor made from Amphioxide™ Sponge Type II inside Nickle foam.

TABLE 1

| | Specific | Energy | Power |
|---|---|---|---|
| | Capacitance | Density | Density |
| Button cell | 196 F/g | 22.4 Wh/kg | 10.5 KW/kg |
| supercapacitor 2M | | | |
| KCl as electrolyte | | | |

Referring to FIGS. 10-13 and to Table 1, one can appreciate the excellent characteristics of the Amphioxide™ sponge Type II material and its excellent suitability for supercapacitor.

Although the above embodiments of the present invention has been described with a certain degree of particularity, it is to be understood that the present disclosure has been made only by way of illustration and that numerous changes in the details of construction and arrangement of parts may be resorted to without departing from the spirit and the scope of the invention.

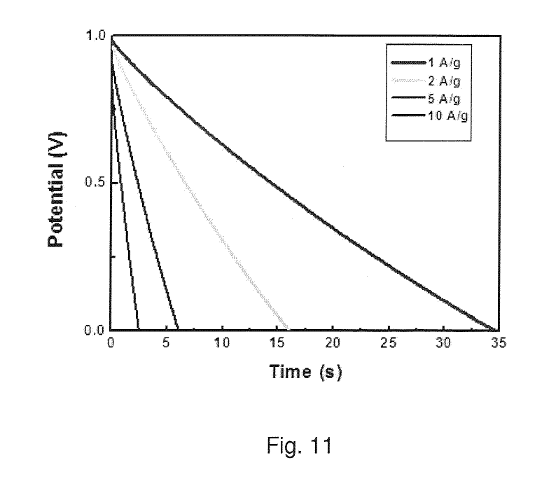

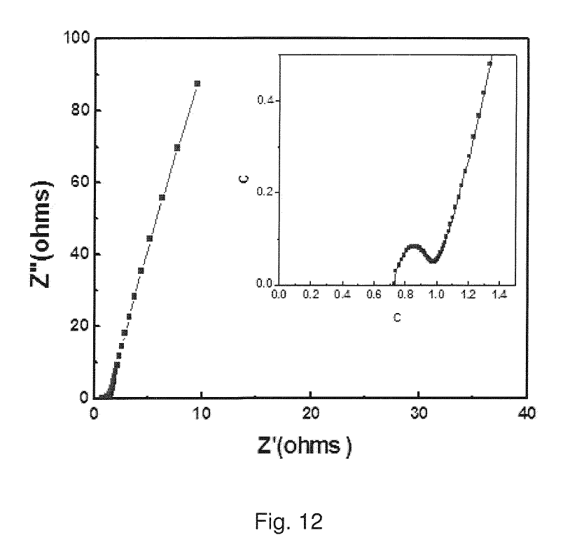

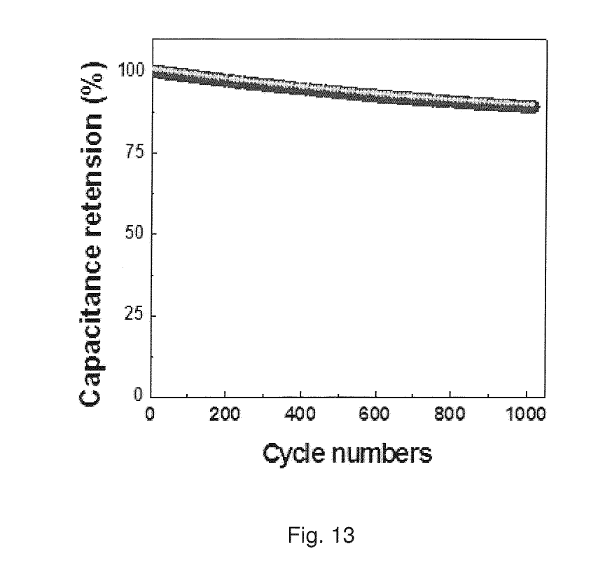

FIG. 11 shows a charge-discharge curve for the button cell supercapacitor made from graphene foam inside a Nickle foam. FIG. 12 shows impedance spectroscopy data for a button cell supercapacitor made from graphene foam inside a Nickle foam. FIG. 13 shows stability data for a button cell supercapacitor made from graphene foam inside a Nickle foam. FIG. 14 shows a Lithium ion battery data of an embodiment of the invention.

### Example IV

### Amphioxide™ Sponge Type I and II are Hydrophobic

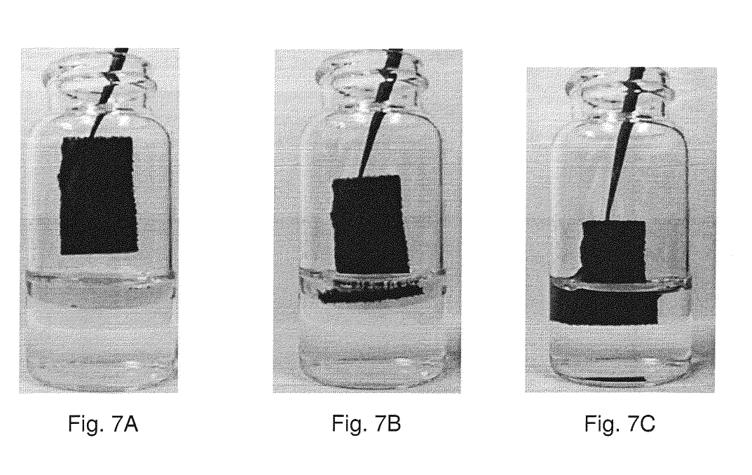

It was surprisingly found that the sponges created in Example I and II are highly hydrophobic. This was surprising since graphene oxide as such is characterized as being hydrophilic. In preliminary experiment it was found that subjecting Sponge II into a mixture of oil and water, the sponge was capable of adsorbing the oil from the water. This process is demonstrated in FIG. 7. This finding led the inventors to experiment more with the material and to develop these characteristics further.

The contact angle of a sponge prepared in accordance with Example IV is 135°.

### Example V

### Coating Artificial or Natural Sponge with Few Layered Graphene (Mesograf®)

Instead of using graphene oxide (Amphioxide™), a few layered graphene (Mesograf®) was used here as a starting material. It was found that it is possible to coat an existing artificial sponge with Mesograf® with a method presented here to create a low-cost sponge highly efficient in removing oil from aqueous solution.

In one embodiment, loading of graphene in the sponge is controlled in order to control the contact angle. Graphene is bonded into the sponge through binding agents. The binding agent is used for binding the graphene with the sponge tightly in order to not losing graphene during recycling. The binding agent could be silicone based coupling agent or Titanium based coupling agents.

Generally the following method is used to prepare this embodiment of the invention:
1. Cleaning sponge ultrasonically with acetone for 5-60 minutes by placing the sponge in a container filled with acetone. Rinsing thoroughly with DI water after ultrasonication. Placing in vacuum oven at 50-100° C. to dry for 1-5 hours.
2. Preparing graphene solution. Weighing few layered graphene (Mesograf®) or single layered graphene and adding certain amount of ethanol or other suitable solvent. Sonicating the mixture for 5-60 minutes directly before step 4.
3. Removing the dried sponge from the vacuum oven. Immediately weighing the sponge and record the dry mass.
4. Dipping the sponge in the graphene solution (0.5-20 wt %), compressing it and relaxing it once. Placing it back in the vacuum oven at 80-100° C. for 2 hours.
5. Preparing the binding solution with certain concentration. Add acetone and sonicating the mixture for 15-60 minutes directly prior to step 6.
6. Removing the graphene sponge from the vacuum oven and weighing the dry mass.
7. Dipping the graphene sponge in the PDMS solution and placing it back in the vacuum oven at 80-100° C.
8. Weighing the sponge again once it is removed from the oven.
9. Repeating step 4-7 until the desired loading of graphene and certain contact angle are reached. Preferred contact angle is greater than 150°.

In the above method, the dipping time is controlled to ensure certain amount of coating can be reached. The loading of graphene on the sponge is in the range of 5-20 wt %. Further, in a preferred embodiment, the contact angle of a graphene sponge is 136°.

The resulting graphene-coated sponge has high absorption capacity to petroleum or non-petroleum based hydrocarbon containing substances. Examples of petroleum based oils are pump oil, gasoline, jet fuels, diesel oils, fuel oils, crude oils. Non petroleum oils may be animal fats, oils or greases, fish and marine mammal oils, or vegetable oils such as oils from nuts, fruits, seeds, and kernels.

Further, the oil retained inside the sponge can be released by pressing the sponge through outside mechanical force and the sponge can be recycled to extract oil again. The amount of the released oil from the sponge varies from 95-98% depending on the force of the press and the number of cycles of the re-usage.

### Example VI

### Preparation of Graphene Sponge

In this example an artificial sponge made of plastic was used. Small pieces of about one cubic inch of the sponge were cut and cleaned ultrasonically with acetone. Ultrasonic cleaning uses cavitation bubbles (small liquid free areas) induced by high frequency pressure (sound) waves to agitate the liquid. The agitation produces high forces on contaminants adhering to surfaces of the sponge. The intention is to thoroughly remove all traces of contamination tightly adhering or embedded onto sponge surfaces. Acetone was chosen for the solvent, but other solvents such as isopropyl alcohol could also be used. Contaminants can include dust, dirt, oil, pigments, rust, grease, algae, fungus, bacteria, lime scale, polishing compounds, flux agents, fingerprints, soot wax and mold release agents, biological soil like blood, and so on. After the ultrasonication, the sponge pieces were rinsed thoroughly with DI water and placed in a vacuum oven at 80-100° C. to dry for about 2 hours to remove the acetone.

A graphene solution was prepared by measuring 1-10 mg Mesograf® into a 20 mL vial. 15 mL of ethanol was added and the solution was sonicated for 15 minutes in a low power sonication bath in order to disperse the graphene.

The dried sponge was removed from the vacuum oven and immediately weighed and the dry mass was recorded.

The sponge pieces were then immersed in the graphene solution. The pieces were compressed and relaxed in order to absorb as much graphene solution as possible. Once the sponge pieces did not absorb any more solution they were placed back in the vacuum oven for 2 hours.

A binding solution was prepared by weighting out 3.5 mg of the binding agents such as PDMS or other silicone based coupling agent into a 20 mL vial. 15 mL of xylene or acetone was added and the solution was sonicated for 30 minutes. Binding agent is necessary to bind the graphene into the sponge fibers and to allow reuse of the sponge. Without binding agent the sponge can be only used for 1-2 cycles.

The graphene sponges were removed from the vacuum oven and dipped in the binding agents solution (in a fume hood) and placed back in the vacuum oven. The sponges were left into the vacuum oven for at least 16 hours for complete drying. The process is repeated for a few times (usually 1 to 2 times). Usually the resulting mass weight loading of graphene on sponge is 5-10 wt %.

The graphene sponge may be formatted to any desired form by cutting, grinding, or pressing. Desired forms include forms such as cubes, spheres, mats, nets, chains and granulate. Different forms may be used for different purposes.

### Example VII

### Graphene Sponge Absorbs Oil but does not Absorb the Water

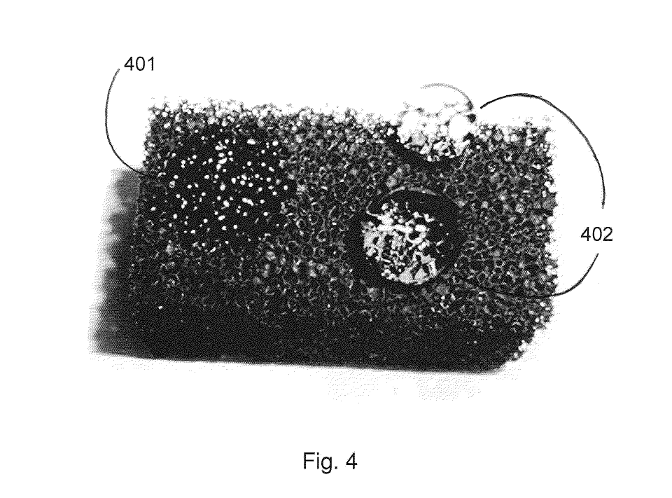

A sponge of about 1 cubic inch was coated with graphene as described in Example VI. Droplets of water were placed on the sponge. FIG. 4 shows that the droplets stayed on the top of the sponge and did not penetrate the sponge. The water droplets did not penetrate the sponge within at least 2 hours. When droplets of pump oil were placed on the sponge, they penetrated the sponge within seconds. FIG. 4 shows penetration of the oil droplets. Specifically, oil droplet 401 will be absorbed by the composition while water droplets 402 are unable to penetrate the composition.

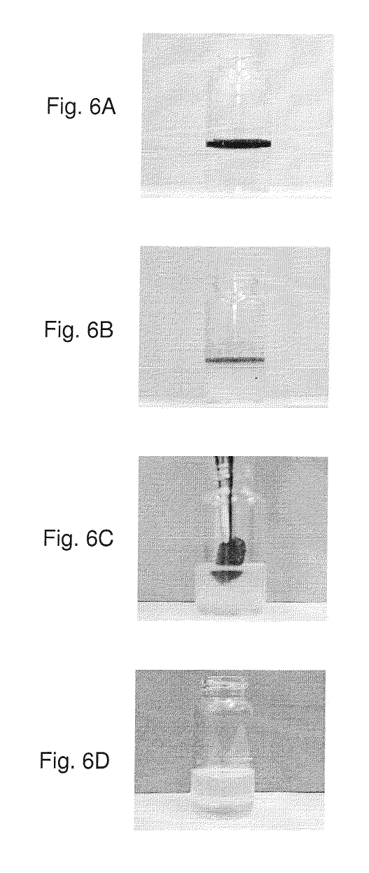

In a further experiment the graphene coated sponge of this invention was used in separation of oil from water. This experiment is shown in FIGS. 6A-6D. In the first step shown in the figure, the bottle contains a mixture of water and pump oil. The oil is on top of the water layer. In second step in the figure shows how the sponge of this invention adsorbs the oil from the top of the water. In the third step the sponge is dipped into the water phase and in the fourth step it is shown how the water level stays the same, i.e. the sponge is hydrophobic and does not take up the water. The sponge is also capable of holding the oil it absorbed and no oil is released from the sponge without squeezing. By squeezing 95-98% of the oil can recovered and the sponge can be reused.

Referring to FIGS. 7A-7C, the process described in Example VII is shown.

When a sponge without graphene coating was placed in water oil mixture it absorbed both the water and oil and thus the oil could not be recovered from the sponge.

### Example VIII

### Graphene Sponge Absorbs the Oil Several Times Faster than an Untreated Sponge

When a sponge without graphene was placed in pump oil it absorbed about 30 times of its own weight of pump oil. The absorption took about 5-10 minutes.

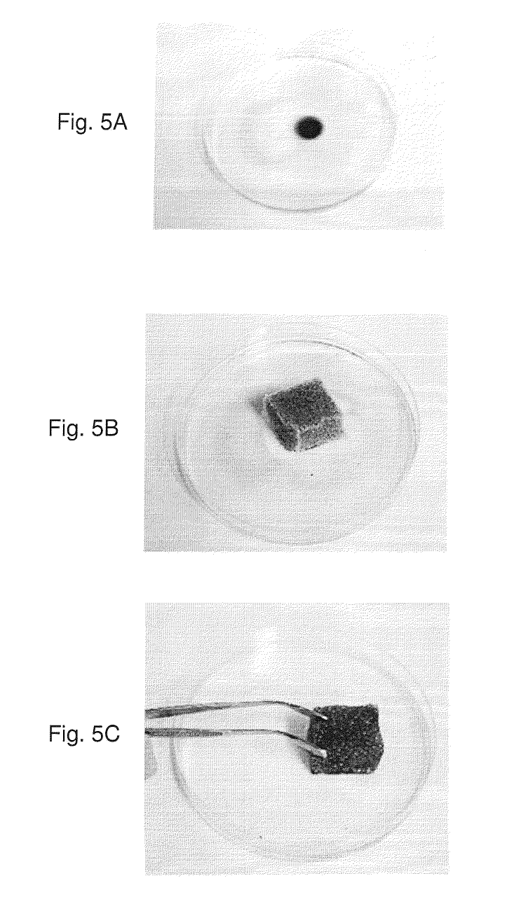

When a graphene coated sponge of this invention of same size as the uncoated sponge above was dropped in pump oil the sponge absorbed about 34 times of its own weight of pump oil. Importantly, the absorption took few seconds. FIGS. 5A-5C illustrate this process.

Thus the graphene coating increased the sponge's capacity of oil uptake (12%) and notably improved absorption by a factor of roughly 100 times.

Further, if the pump oil contained water the sponge of this invention did not absorb any water (Example VII), and therefore the oil can be recovered from the sponge by squeezing. Thus the material of this invention not only provides a method to separate oil from oil/water mixtures, but it also allows extremely fast absorption of oil and recovery of the oil.

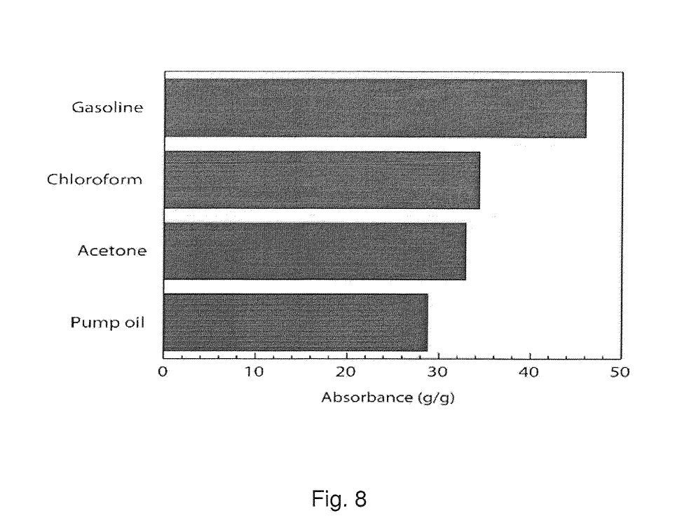

The sponge according to this invention can be used for separations and recovery of any kind of oils. It works equally well with petroleum based as well as non-petroleum based oils. The absorbance of a sponge prepared in accordance with Example VII in different media is shown in FIG. 8. Accordingly, it can be used for industrial clean ups for onsite oil spills, spills of cooking oils in commercial and residential kitchens, cleaning oily garage floors, to separate oil and water phase in emulsions during chemical processes and so on.

The sponge material of this invention may be constructed to be a net, a mat, a chain or any other configuration and upon releasing the material onto an oil spill it will absorb the oil leaving water behind. Later, the oil can be extracted from the material and stored properly. The material is reusable after the oil is released from it.

Another application for the material of this invention would be extracting oil from the feathers and skin of birds exposed to an oil spill. The material could be used to make wraps or other type of configurations into which the exposed birds could be wrapped. Once the material is in contact with the oil on the skin or feathers the oil will be absorbed and the bird can be released without the oil covering.

A further application of the material would be to use it to extract oil from oil sands waste water and shale gas waste water in refinery. The material would be made into contact with the waste water and shale gas waste water. Once the material has reached its capacity to absorb oil, the oil would be released from the material by squeezing or applying press on the sponge and collected in containers.

A further application of the material of the present invention would be to use it to extract oil from an oil spill occurring in a large body of water as well as to extract oil from and oil spill occurring on solid ground.

A further application of the composition of the invention is to use it to extract organic solvents from water contaminated with such solvents. Organic solvents that could be removed in this was include, but are not limited to benzene, Chloroform, and hexane.

1. A sponge-like nanomaterial obtained from graphene oxide with steps comprising:
a. sonicating graphene oxide in DI-H₂O-solution; and
b. freezing the sonicated material.

2. The sponge-like nanomaterial of claim 1, wherein the sponge-like nanomaterial is further purged in presence of argon gas and heated to 900° C. for a period of time and thereafter cooled.

3. The sponge-like nanomaterial of claim 2, wherein said sponge-like nanomaterial is contained inside a Nickle foam.

4. The sponge-like nanomaterial of claim 1, wherein the material is hydrophobic and has a capacitance of at least 196 F/g.

5. The sponge-like nanomaterial of claim 1, wherein the material is suitable for use as a supercapacitor.

6. The sponge-like nanomaterial of claim 1, wherein the material is suitable for use in the construction of a Lithium battery.

7. The sponge-like nanomaterial of claim 1, wherein the material is capable of separating oil from water.

8. The sponge-like nanomaterial of claim 1, wherein the material is capable of separating an organic solvent from water.

9. A device to rescue birds exposed to oil spill; wherein the device comprises a wrap made of a sponge-like nanomaterial obtained from graphene or graphene oxide, wherein said sponge-like material is capable of absorbing the oil from the feathers and skin of the bird.

10. A Lithium battery comprising:
a half cell comprised of a sponge-like nanomaterial obtained from graphene oxide;
a Lithium metal serving as a reference electrode; and
and a 1M solution of LiPF₆ as an electrolyte.

11. A composition of matter, said composition comprising a natural or artificial sponge having a plurality of fibers, wherein the fibers are at least partially coated with graphene.

12. The composition of matter of claim 11, wherein the graphene is bound to the fibers with a binding agent.

13. The composition of matter of claim 12, wherein the binding agent is a silicone based coupling agent.

14. The composition of matter of claim 13, wherein the composition is oleophilic and hydrophobic.

15. The composition of claim 14, wherein the composition is capable of absorbing 30-200 times of its weight.

16. The composition of claim 15, wherein the composition absorbs at least 30 times of its weight of oil in less than 10 seconds.

17. The composition of claim 11, wherein the composition comprises 5-20 w-% of graphene.

18. A composition of matter of claim 11 made with a process comprising the steps of:
a. dipping a dried and de-greased natural or artificial sponge into a graphene-solvent solution;
b. drying the sponge in vacuum oven;
c. dipping into a solution containing binding agent;
d. drying the sponge in vacuum oven;
e. optionally repeating step a-d; and
f. optionally grinding, pressing, or cutting the composition to a desired format.

19. The composition of matter of claim 18, wherein the desired format is selected from the group of a mat, a net, a chain, a cube, a sphere, or granulate.

20. A method to separate oil from water said method comprising the steps of:
a. Providing a natural or artificial sponge having a plurality of fibers, wherein the fibers are at least partially coated with graphene;
b. Contacting an oil-water mix with the composition;
c. Allowing the composition to absorb the oil from the mix;
d. Removing the composition;
e. Extracting the oil from the composition; and
f. Reusing the composition.

21. The method of claim 20, wherein the oil water mixture is ocean water-oil mixture.

22. The method of claim 20, wherein the composition is provided in a form selected from a net, a mat, a sphere, a cube and granulate.

23. A method to extract oil from waste water of oil sands, said method comprising the steps of:
a. Providing a natural or artificial sponge having a plurality of fibers, wherein the fibers are at least partially coated with graphene;
b. Contacting the waste water from oil sands with the composition;
c. Allowing the composition to absorb the oil from waste water from the oil sand;
d. Removing the composition when no more absorption takes place; and
e. Extracting the oil from the composition.
